(19) United States
(12) Patent Application Publication
(10) Pub. No.: US 2017/0045402 A1
(43) Pub. Date: Feb. 16, 2017

(54) ARRANGEMENT AND METHOD FOR MEASURING TEMPERATURE

(71) Applicant: CONFLUX AB, Järfälla (SE)

(72) Inventor: Tom Francke, Sollentuna (SE)

(21) Appl. No.: 15/102,672

(22) PCT Filed: Dec. 29, 2014
(86) PCT No.: PCT/SE2014/051577

§ 371 Date: Jun. 8, 2016

(30) Foreign Application Priority Data
Jan. 17, 2014 (SE) 1450048-2

(51) Int. Cl. G01K 7/22; G01K 1/20

(52) U.S. Cl. CPC G01K 7/22; G01K 7/226; G01K 1/20

(57) ABSTRACT

An arrangement for measuring temperature comprises a temperature sensor (11) including a main section (12) and separated electrical terminals (13, 14), wherein the main section (12) has an accentuated temperature dependent electrical resistivity and the electrical terminals are electrically connected to the main section (12); and an arrangement (15) for measuring an electrical resistance configured to measure the electrical resistance over the electrical terminals (13, 14), wherein the measured electrical resistance is indicative of the temperature of an object in thermal contact with the main section. The main section (12) may have an electrical resistivity as a function of temperature within a specified temperature interval, such as e.g. −100 to +100 degrees Celsius, such that the temperature derivative of the electrical resistivity within the specified temperature interval is strictly increasing. The main section (12) may have an electrical resistivity which is exponentially increasing with temperature within the specified temperature interval.

### TECHNICAL FIELD

The technical field is generally directed to arrangements and methods for measuring temperatures.

### DESCRIPTION OF RELATED ART AND BACKGROUND

Electrical systems are today used extensively throughout the world. Electrical systems are groups of electrical components connected to carry out some operation. Often the systems are combined with other systems. They may be subsystems of larger systems and/or may have subsystems of their own.

Electrical components are discrete devices or physical entities, which have each one or more functions within the electrical system. In electrical system design, electrical components are selected, arranged, and connected to obtain electrical systems or subsystems, which are capable of carrying out desired operations.

Many of these electrical components generate heat while being used, which increase temperature of and around such electrical components. Temperature monitoring and control is of outermost importance in most electrical systems to avoid that some electrical components or subsystems become overheated and will note operate properly or at all. Overheating may cause electrical components or subsystems to have shorter lifetime and/or to become damaged.

Flexible and custom made temperature monitoring and control may be of highest importance in many other kinds of systems and apparatuses, wherein heat is generated, and/or wherein temperature is affected, by other sources than electrical sources. Such systems and apparatuses may comprise heat generation systems, cooling systems, energy conversion systems, radiation based apparatuses or systems, vehicles, and mechanical apparatuses and systems.

### SUMMARY

It is an aim of this document to reveal novel applications for temperature dependent materials that can be useful as flexible and custom made temperature sensors in a variety of systems including power sources, electronic circuits, control systems, regulation systems, heating systems, cooling systems, transportation systems, lightning systems, communication systems, and power generation and distribution systems.

A first aspect refers to an arrangement for measuring temperature comprising a temperature sensor including a main section and separated electrical terminals, wherein the main section has a temperature dependent electrical resistivity, preferably an accentuated temperature dependent electrical resistivity such as that of a PTC (Positive Temperature Coefficient) material, and the electrical terminals are electrically connected to the main section. An arrangement for measuring an electrical resistance is configured to measure the electrical resistance over the electrical terminals, wherein the measured electrical resistance is indicative of the temperature of an object in thermal contact with the main section. Thermal contact is ensured if the object is placed in physical contact with the temperature sensor, since heat will then be transported to the main section. If the object is transporting a current, the temperature sensor may be covered by an electrically insulating, but heat conducting, layer, in physical contact with which the object can be placed to not interfere with the operation of the object.

The electrical terminals may be located on the same side of the main section or on opposite sides of the main section.

In one embodiment, evaluating means is operatively connected to the arrangement for measuring an electrical resistance, wherein the arrangement for measuring an electrical resistance is configured to transmit the measured electrical resistance to the evaluating means. The evaluating means may be configured to (i) hold or receive a threshold resistance corresponding to a threshold temperature, (ii) compare the measured electrical resistance with the threshold resistance, and (ii) send instructions to any of an alarming device, a cooling device, or a heating device in response to the comparison, in particular if the comparison reveals that the temperature, of which the measured electrical resistance is indicative, is higher than the threshold temperature, to which the threshold resistance is corresponding.

The evaluating means may be implemented as electrical circuitry or as a microprocessor. In the former case, the evaluating means may e.g. be any of a comparator, a Schmidt trigger, and an operational amplifier.

In one embodiment, the main section is formed as an elongated section wherein the electrical terminals are electrically connected to the main section in two opposite end portions thereof. The main section may have a flat shape with a main extension direction which changes along the main section to extend over a two-dimensional area, such as e.g. a meander like shape extending over a two-dimensional area. By such embodiment, an arrangement for measuring a local maximum temperature is obtained. A local temperature increase along the meander shaped main section would cause the resistance to rise significantly if the resistance increases strongly with temperature. Thus, this embodiment can be used to monitor temperature over a two-dimensional area (or even three-dimensional area after suitable modifications) and to indicate whether a local temperature at some location of the area increases by means of monitoring the resistance between the electrical terminals. This embodiment may, depending on the resistance at normal low temperatures, only be applicable to smaller areas. In order to cover larger areas and to ensure that a high sensitivity is obtained, corresponding to low resistance at normal low temperatures, some modifications may have to be made.

To this end, an embodiment is directed towards an elongated main section having separated electrically conducting structures arranged alternately on a top surface and a bottom surface of the elongated main section along the main extension of the elongated main section. Each separated electrically conducting structure arranged on the top surface of the elongated main section may overlap with two electrically conducting structures arranged on the two bottom surface of the elongated main section.

In an alternative embodiment, the elongated main section has separated electrically conducting structures arranged on either one of a top surface and a bottom surface of the elongated main section along the main extension of the elongated main section.

The main section may be of a PTC material.

The main section may have a trip temperature within a specified temperature interval, such as e.g. −100 to +100 degrees Celsius, above which trip temperature the temperature dependence of the electrical resistivity is stronger than the temperature dependence of the electrical resistivity below the trip temperature.

The main section may have an electrical resistivity as a function of temperature such that the temperature derivative of the electrical resistivity within the specified temperature interval is strictly increasing.

The main section may have an electrical resistivity which is exponentially increasing with temperature at least within the specified temperature interval.

The arrangement for measuring an electrical resistance of the first aspect is preferably configured to measure the temperature within the specified temperature interval.

The main section and the electrical terminals may be provided as a sheet, e.g. a laminated sheet, which may be flexible. Such laminated sheet may be flexible and can thus be shaped around a curved surface. This flexibility may be provided for each arrangement disclosed herein.

In one embodiment, the main section is of a compound comprising an electrically insulating bulk material, electrically conductive particles of a first kind, and electrically conductive particles of a second kind, wherein the electrically insulating bulk material holds the electrically conducting particles of the first and second kinds in place; the electrically conducting particles of the second kind are smaller than the electrically conducting particles of the first kind; the electrically conducting particles of the second kind are more in number than the electrically conducting particles of the first kind; and the electrically conducting particles of the second kind have higher surface roughness than the electrically conducting particles of the first kind, wherein the electrically conducting particles of the second kind comprise tips and the electrically conducting particles of the first kind comprise even surface portions. The tips of the electrically conducting particles of the second kind may be so sharp that the very ends of the tips comprise a single atom or a few atoms only.

The electrically conducting particles of the first and second kinds are arranged to form a plurality of current paths through the compound, wherein each of the current paths comprises galvanically connected electrically conducting particles of the first and second kinds and a gap between a tip of one of the electrically conducting particles of the second kind and an even surface portion of one of the electrically conducting particles of the first kind, which gap is narrow enough to allow electrons to tunnel through the gap via the quantum tunneling effect. The electrically insulating bulk material has a thermal expansion capability such that it expands with temperature, thereby increasing the gap widths of the current paths, which in turn increases the electrical resistivity.

The insulating bulk material may comprise a cross-linked polymer or elastomer, such as for example a silicone, e.g. polydimethyl siloxane, and optionally a filler, thickener, or stabilizer, such as for example silica, distributed in the compound. The electrically conducting particles of the first and second kinds are carbon-containing particles, such as for example carbon blacks.

The number of the current paths through the compound and the widths of the gaps therein at any given temperature are provided depending on the thermal expansion capability of the electrically insulating bulk material to obtain a desired temperature dependent electrical resistivity of the compound in a selected temperature interval, e.g. in the above identified temperature interval.

In one embodiment, the arrangement comprises a plurality of a temperature sensor as defined above. The plurality of the temperature sensors may be arranged in a one- or two-dimensional array.

In one version of the above embodiment, the plurality of the temperature sensors are serially connected to one another, wherein the arrangement for measuring an electrical resistance is configured to measure the electrical resistance over the series connection. Hereby, an arrangement is obtained for measuring a local maximum temperature over a region covered by the temperature sensors.

The main sections of the plurality of the temperature sensors may be formed in one piece, e.g. in the form of an elongated body having flat shape with a main extension direction which changes along the elongated body to cover a two-dimensional area. The elongated body may have a flat meander like shape.

A local temperature increase along the elongated body would cause the resistance to rise significantly if the resistance increases strongly with temperature. Thus, this embodiment can be used to monitor temperature over a two-dimensional area (or even three-dimensional area after suitable modifications) and to indicate whether a local temperature at some location of the area increases by means of monitoring the serial resistance of the temperature sensors.

In another version of the above embodiment, the arrangement for measuring an electrical resistance is configured to measure the electrical resistance over the electrical terminals of each of the temperature sensors independently, wherein the electrical resistance of each of the temperature sensors is indicative of the temperature of a local portion of an object in thermal contact with the main section of that temperature sensor. Hereby, temperature imaging arrangement is obtained. A spatially resolved temperature can be measured over a two-dimensional area or even over a three-dimensional area after suitable modifications.

The arrangement for measuring an electrical resistance may comprise one electrical resistance meter for each temperature sensor, such that the electrical resistances of the temperature sensors can be measured simultaneously.

Alternatively, the arrangement for measuring an electrical resistance may comprise one or more electrical resistance meters and a switching network arranged such that each temperature sensor can individually be electrically connected to the electrical resistance meter or one of the electrical resistance meters during a measurement period, such that the electrical resistances of some or all of the temperature sensors can be measured during separated measurement periods by a single electrical resistance meter.

Generally, main sections of the plurality of temperature sensors may be electrically insulated from one another or may be formed in one piece.

The arrangements disclosed herein may be used for batteries, such as e.g. lithium ion batteries, which are being used in aircraft, mobile phones, and electric vehicles, which batteries may be locally over heated (in a small area/point) causing damage or fire. Such damage or fire can be avoided by warning or shut-off systems connected to any of the disclosed arrangements.

A second aspect refers to a method for measuring temperature. According to the method, a temperature sensor including a main section and separated electrical terminals are provided, wherein the main section has a temperature dependent electrical resistivity, preferably an accentuated temperature dependent electrical resistivity, and the electrical terminals are electrically connected to the main section. An object, of which a temperature is to be measured, is arranged in thermal contact with the main section and the electrical resistance over the electrical terminals is measured, wherein the electrical resistance is indicative of a temperature of the object in thermal contact with the main section. Thermal contact is ensured if the object is placed in physical contact with the temperature sensor, since heat will then be transported to the main section. If the object is transporting a current, the temperature sensor may be covered by an electrically insulating, but heat conducting, layer, in physical contact with which the object can be placed to not interfere with the operation of the object.

The method of the second aspect may be modified to carry out any of the functions, actions, and/or operations disclosed above with reference to the first aspect.

In one embodiment the plurality of temperature sensors are formed in a laminated layer comprising a layer having a temperature dependent electrical resistivity sandwiched between (i) two electrically conducting layers or (i) one electrically conducting layer and one electrically insulating layer (which may be heat conducting). The main sections of the temperature sensors are formed in, or are constituted by, the layer having temperature dependent electrical resistivity. The first case (i) is applicable to the embodiments having electrical terminals on two opposite sides of the main sections and the second case (ii) is applicable to the embodiments having electrical terminals on only one side of the main sections. The electrical terminals, and optionally their connections, may be formed in the electrically conducting layer(s), being metallic layer(s), such as e.g. copper layer(s), by means of patterning and etching the electrically conducting layer(s), or by means of punching. The main sections may be formed by means of punching through the sandwiched layer.

In one version of the first case (i), the sandwiched layer is formed such that it extends only at areas of the laminated layer, wherein the electrical terminals, and optionally their connections, of any of the electrically conducting layers are present.

In one version of the second case (ii), the sandwiched layer is formed such that it extends only at areas of the laminated layer, wherein the electrical terminals, and optionally their connections, of the electrically conducting layer are present and at areas between the electrical terminals.

Further characteristics and advantages will be evident from the detailed description of embodiments given hereinafter, and the accompanying FIGS. 1-9, which are given by way of illustration only.

### BRIEF DESCRIPTION OF THE DRAWINGS

FIGS. 1a-b illustrate each, schematically, in side view, an arrangement for measuring temperature according to an embodiment.

FIG. 2 illustrates, schematically, in top view, parts of an arrangement for measuring temperature comprising a plurality of temperature sensors according to an embodiment.

FIGS. 3a-b illustrate, schematically, in top and bottom views, parts of an arrangement for measuring a local maximum temperature according to an embodiment.

FIG. 4 illustrates, schematically, in top view, parts of an arrangement for measuring a local maximum temperature according to an embodiment.

FIG. 5 illustrates, schematically, in top view, parts of an arrangement for measuring a temperature spatially resolved according to an embodiment.

FIGS. 6a-b illustrate, schematically, in top and bottom views, parts of an arrangement for measuring a temperature spatially resolved according to an embodiment.

FIG. 7 illustrates, schematically, a portion of a compound having a temperature dependent electrical resistivity for use in an arrangement for measuring temperature according to an embodiment.

FIG. 8 illustrates, schematically, a detail of the structure of the compound in FIG. 7 in more detail.

FIG. 9 illustrates, schematically, a portion of the compound in FIG. 7, wherein a plurality of current paths through the compound is shown.

### DETAILED DESCRIPTION OF EMBODIMENTS

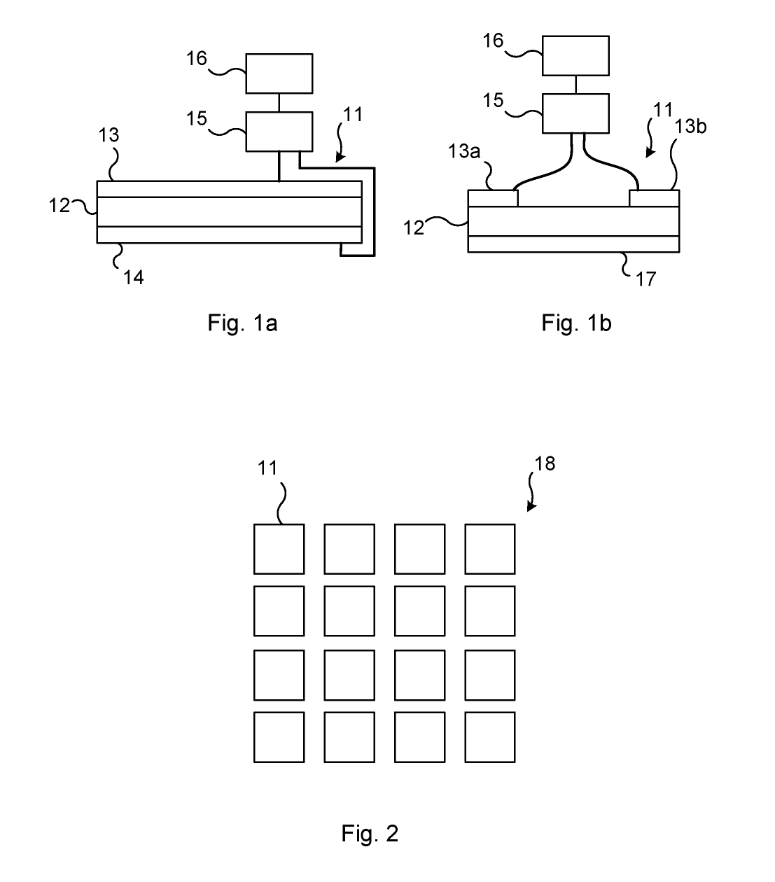

FIGS. 1a-b illustrate each, schematically, in side view, an arrangement for measuring temperature according to an embodiment.

Each arrangement comprises a temperature sensor 11 including a main section 12 and separated electrical terminals 13, wherein the main section 12 has a temperature dependent electrical resistivity, preferably an accentuated temperature dependent electrical resistivity, and the electrical terminals 13, 14 (FIG. 1a) and 13a-b (FIG. 1b) are electrically connected to the main section 12. An arrangement 15 for measuring an electrical resistance is configured to measure the electrical resistance over the electrical terminals 13, 14 and 13a-b, wherein the measured electrical resistance is indicative of the temperature of an object in thermal contact with the main section 12.

Evaluating means 16 may be operatively connected to the arrangement 15 for measuring an electrical resistance, which arrangement 15 is configured to transmit the measured electrical resistance to the evaluating means 16. The evaluating means 16 may be configured to perform the following actions: (i) holding or receiving a threshold resistance corresponding to a threshold temperature, (ii) comparing the measured electrical resistance with the threshold resistance, and (ii) sending instructions to any of an alarming device, a cooling device, or a heating device in response to the comparison, in particular if the comparison reveals that the temperature, of which the measured electrical resistance is indicative, is higher than the threshold temperature, to which the threshold resistance is corresponding.

FIG. 1a illustrates an embodiment wherein the electrical terminals 13, 14 are located on opposite sides of the main section 12, whereas FIG. 1b illustrates an embodiment wherein the electrical terminals 13a-b are located on the same side of the main section. In the latter embodiment a protective electrically insulating coating 17 may be formed on a side of the main section 12, which is opposite to the side, on which the electrical terminals 13a-b are located.

In each embodiment, the main section 12, the electrical terminals 13, 14 (FIG. 1a) and 13a-b (FIG. 1b), and the electrically insulating coating 17 (FIG. 1b) are provided as a laminated, preferably flexible, sheet.

The main section 12 may be of a PTC material, it may have a trip temperature within a specified temperature interval, such as e.g. −100 to +100 degrees Celsius, above which trip temperature the temperature dependence of the electrical resistivity is stronger than the temperature dependence of the electrical resistivity below the trip temperature, it may have an electrical resistivity as a function of temperature such that the temperature derivative of the electrical resistivity within the specified temperature interval is strictly increasing, or it may have an electrical resistivity which is exponentially increasing with temperature at least within the specified temperature interval.

In one version, the main section 12 is formed as an elongated section wherein the electrical terminals 13, 14 (FIG. 1a) and 13a-b (FIG. 1b) are electrically connected to the main section 12 in two opposite end portions thereof. The main section 12 may have a flat shape with a main extension direction which changes along the main section 12 such that the main section 12 extends over a two-dimensional area. Particularly, the main section 12 may have a flat meander like shape to extend over a two-dimensional area.

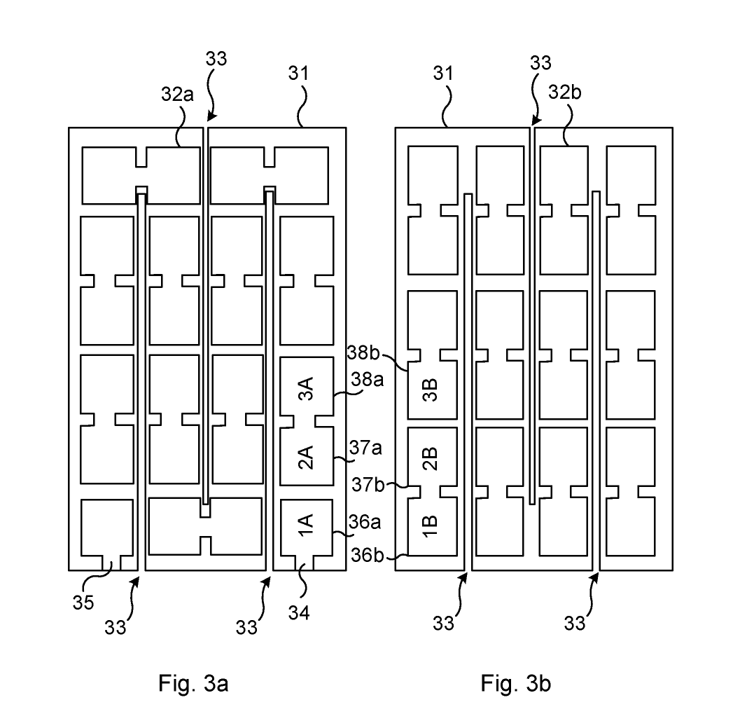

FIG. 2 illustrates, schematically, in top view, an arrangement for measuring temperature comprising a plurality of temperature sensors 11 according to an embodiment. The temperature sensors 11 may be arranged in a one- or two-dimensional array 18 and may be electrically connected in various configurations, which will be described further below with reference to FIGS. 3-6.

If the temperature sensors 11 are serially connected to one another, an arrangement for measuring an electrical resistance may be configured to measure the electrical resistance over the series connection. In such instance, the electrical series resistance may be monitored, and a sudden change (increase) in the electrical series resistance may be indicative of a sudden temperature change (increase) of a local portion of an object in thermal contact with the main section of one of the temperature sensors 11.

Alternatively, the arrangement for measuring an electrical resistance may be configured to measure the electrical resistance over the electrical terminals of each of the temperature sensors 11 independently. In such instance, the electrical resistance of each of the temperature sensors 11 is indicative of the temperature of a local portion of an object in thermal contact with the main section of that temperature sensor 11.

FIGS. 3a-b illustrate, schematically, in top and bottom views, parts of an arrangement comprising a plurality of temperature sensors for measuring a local maximum temperature according to an embodiment. The main sections of the temperature sensors are formed in one piece, which form an elongated body 31 having a sheet shape, with upper electrical terminals 32a and lower electrical terminals 32b. Cuts 33 are formed in the elongated body 31 such that a body is formed with a main extension direction which changes along the body 31 in a meander like shape.

The electrical terminals are formed as pads formed on opposite sides of the elongated body 31. The first temperature sensor comprises an upper electrical terminal 36a and a lower electrical terminal 36b, the second temperature sensor comprises an upper electrical terminal 37a and a lower electrical terminal 37b, the third temperature sensor comprises an upper electrical terminal 38a and a lower electrical terminal 38b, etc. The temperature sensitive region of each temperature sensor comprises the part of the elongated body 31 lying between the electrical terminals of the temperature sensor. For this reason, all other portions of the elongated body could, in principle, be dispensed with, e.g. removed.

From FIGS. 3a-b it can bee seen that every second temperature sensor is electrically connected to the next temperature sensor on the upper side of the elongated body 31, and every second temperature sensor is electrically connected to the next temperature sensor on the lower side of the elongated body 31. The first and the last temperature sensors are electrically connected to input and output terminals 34, 35, via which the temperature sensors can be connected to an arrangement for measuring an electrical resistance, such as the one of FIGS. 1a-b. Also evaluating means such as the evaluating means 16 of FIGS. 1a-b may be connected to the arrangement for measuring an electrical resistance.

It shall be appreciated that in one version, all the electrical terminals of the arrangement for measuring a local maximum temperature, except for the input and output terminals 34, 35 may be dispensed with. In this version, the arrangement can be said to comprise a single temperature sensor having the elongated body 31 as shown in FIGS. 3a-b as main section with the input and output terminals 34, 35 as the electrical terminals of the temperature sensor.

It shall further be appreciated that the arrangement for measuring a local maximum temperature as illustrated in FIGS. 3a-b may be viewed upon as comprising a single temperature sensor having the elongated body 31 as shown in FIGS. 3a-b as the main section with the input and output terminals 34, 35 as the electrical terminals of the temperature sensor. In such instance, electrical terminals shown in FIGS. 3a-b may merely be referred to as separated electrically conducting structures arranged alternately on a top surface and a bottom surface of the elongated body 31 along the main extension of the elongated body 31, wherein each separated electrically conducting structure arranged on the top surface of the elongated body 31 overlaps with two electrically conducting structures arranged on the two bottom surface of the elongated body 31.

In each version of the embodiment of FIGS. 3a-b, the input and output terminals 34, 35 may alternatively be arranged on opposite sides of the elongated body 31.

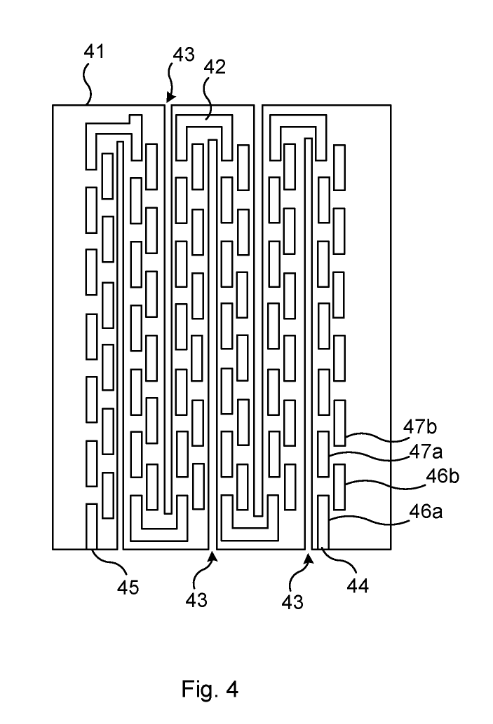

FIG. 4 illustrates, schematically, in top view, parts of an arrangement comprising a plurality of temperature sensors for measuring a local maximum temperature according to an embodiment. The main sections of the temperature sensors are formed in one piece, which form an elongated body 41 having a sheet shape. Cuts 43 are formed in the elongated body 41 such that a body is formed with a main extension direction which changes along the body in a meander like shape.

The electrical terminals are formed as pads formed on the same side of the elongated body 41. The first temperature sensor comprises a portion of the electrical terminal 46a and a portion of the electrical terminal 46h, the second temperature sensor comprises a portion of the electrical terminal 47a and a portion of the electrical terminal 46h, the third temperature sensor comprises a portion of the electrical terminal 47a and a portion of the electrical terminal 47b, etc. Particular connectors 42 connect the electrical terminals at each meandering of the elongated body 41.

The temperature sensitive region of each temperature sensor comprises the surface part of the elongated body 41 lying between the electrical terminals of the temperature sensor. For this reason, all other portions of the elongated body could, in principle, be removed.

From FIGS. 4a-b it can bee seen that every second temperature sensor is electrically connected to the next temperature sensor on one line of the elongated body 41 formed by electrical terminals 46a, 47a, etc., and every second temperature sensor is electrically connected to the next temperature sensor on another line of the elongated body 41 formed by electrical terminals 46h, 47b, etc. The first and the last temperature sensors are electrically connected to input and output terminals 44, 45, via which the temperature sensors can be connected to an arrangement for measuring an electrical resistance, such as the one of FIGS. 1a-b. Also evaluating means such as the evaluating means 16 of FIGS. 1a-b may be connected to the arrangement for measuring an electrical resistance.

In another version, only one of the lines of electrical terminals is present, wherein the first and last one of these electrical terminals are electrically connected to the input and output terminals 44, 45.

It shall be appreciated that in one version, all the electrical terminals of the arrangement for measuring a local maximum temperature, except for the input and output terminals 44, 45 may be dispensed with. In this version, the arrangement can be said to comprise a single temperature sensor having the elongated body 41 as shown in FIGS. 4a-b as main section with the input and output terminals 44, 45 as the electrical terminals of the temperature sensor.

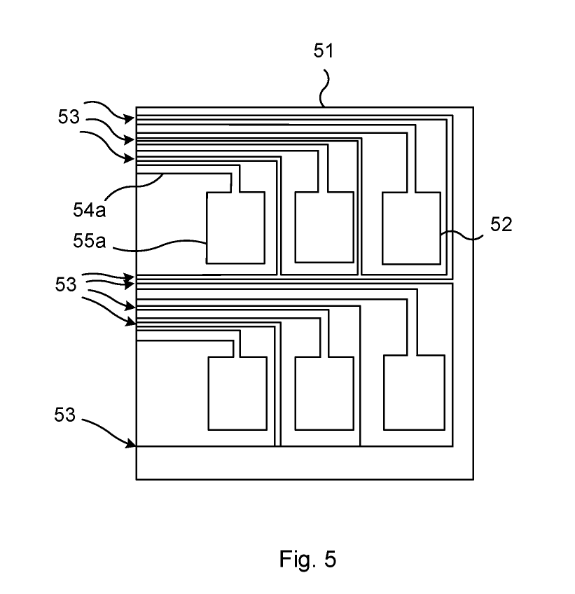

FIG. 5 illustrates, schematically, in top view, parts of an arrangement for measuring a temperature spatially resolved according to an embodiment. The arrangement comprises a one-dimensional array of three temperature sensors 51, 52, 53, each comprising an upper electrode 51a, 52a, 53a with connections 51b, 52b, 53b to one edge of the one-dimensional array, a main section 51c, 52c, 53c, and a lower electrode with connections 51d, 52d, 53 d to the edge of the one-dimensional array as schematically indicated by dashed lines. The upper and lower electrical terminals of each temperature sensor 51, 52, 52 are preferably of the same size and located to completely overlap one another. All connections to the one-dimensional array are located on the same edge.

The temperature sensors 51, 52, 53 is connected to an arrangement for measuring electrical resistances, which is configured to measure the electrical resistances over the electrical terminals of the temperature sensors 11 independently of one another, wherein the electrical resistance of each of the temperature sensors 51, 52, 53 is indicative of the temperature of a local portion of an object in thermal contact with the main section 51c, 52c, 53c of that temperature sensor 51, 52, 53. The arrangement for measuring electrical resistances may comprise one electrical resistance meter for each temperature sensor, such that the electrical resistances of the temperature sensors can be measured simultaneously. Alternatively, switches are provided such that resistances can be measured by a singe resistance meter, one after the other.

Evaluating means such as the evaluating means 16 of FIGS. 1a-b may be connected to the arrangement for measuring electrical resistances, wherein the evaluating means can be modified to perform actions depending on one or more measured resistances.

Note that it is advantageous that the upper connections 51b, 52b, 53b and the lower connections 51d, 52 d, 53d are not overlapping to avoid the risk of current leaking between the upper 51b, 52b, 53b and lower 51d, 52 d, 53d connections of each temperature sensor 51, 52, 53. Also to avoid current leaking, the main sections 51c, 52c, 53c of the temperature sensors 51, 52, 53 are separated, i.e. electrically insulated, from one another.

It shall be appreciated that a plurality, i.e. N, of the one-dimensional array of FIG. 5 may be arranged side by side to form a two-dimensional array 3×N of temperature sensor with all connections thereto located at one edge of the array. The array is also scalable in the other directions by modifying the three temperature sensor array of FIG. 5 to comprise an arbitrary number M of temperature sensor arranged in the fashion outlined in FIG. 5, such that an array having M×N temperature sensors are achieved.

If connections to the temperature sensors can be made at two opposite edges of the array, an M×N array as depicted above can be extended to a 2M×N array by adding N further arrangements with M temperature sensors and arranging them with respect to the first N arrangements such that the connections are located at an opposite edge of the array.

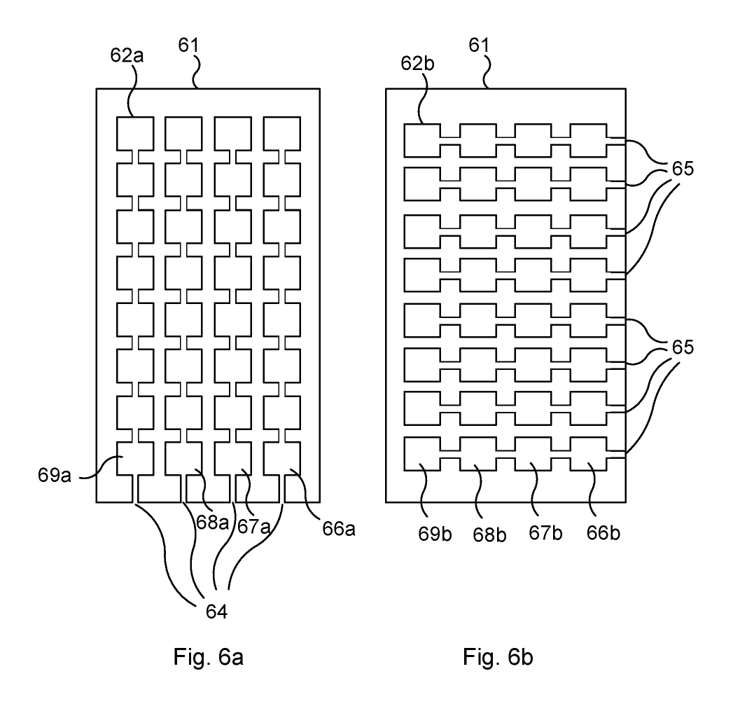

FIGS. 6a-b illustrate, schematically, in top and bottom views, parts of an arrangement comprising a plurality of temperature sensors for measuring a temperature spatially resolved according to an embodiment. The main sections of the temperature sensors are formed in one piece, which form a body 61 having a sheet shape.

The electrical terminals 62a, 62b are formed as pads formed on opposite sides of the body 61. The first temperature sensor comprises an upper electrical terminal 66a and a lower electrical terminal 66b, the second temperature sensor comprises an upper electrical terminal 67a and a lower electrical terminal 67b, the third temperature sensor comprises an upper electrical terminal 68a and a lower electrical terminal 68b, the fourth temperature sensor comprises an upper electrical terminal 69 and a lower electrical terminal 69b, etc.

The temperature sensitive region of each temperature sensor comprises the part of the body 61 lying between the electrical terminals of the temperature sensor. For this reason, all other portions of the elongated body could, in principle, be removed.

From FIGS. 6a-b it can bee seen that the upper electrical terminals 62a are connected to form columns 64, in each of which the upper electrical terminals 62a are connected to one another, and the lower electrical terminals 62b are connected to form electrically connected rows 65, in each of which the lower electrical terminals 62b are connected to one another.

The arrangement of FIG. 6 comprises further an arrangement for measuring an electrical resistance, which includes one or more electrical resistance meters and a switching network arranged such that each temperature sensor can individually be electrically connected to the electrical resistance meter or one of the electrical resistance meters during a measurement period, such that the electrical resistances of at least two of the temperature sensors can be measured during separated measurement periods by a single electrical resistance meter.

In one version, only one electrical resistance meter is provided and the switching network is arranged such that each temperature sensor can individually be electrically connected to the electrical resistance meter during a measurement period, such that the electrical resistances of all temperature sensors can be measured during separated measurement periods by a single electrical resistance meter.

Evaluating means such as the evaluating means 16 of FIGS. 1a-b may be connected to the arrangement for measuring electrical resistances, wherein the evaluating means can be modified to perform actions depending on one or more measured resistances.

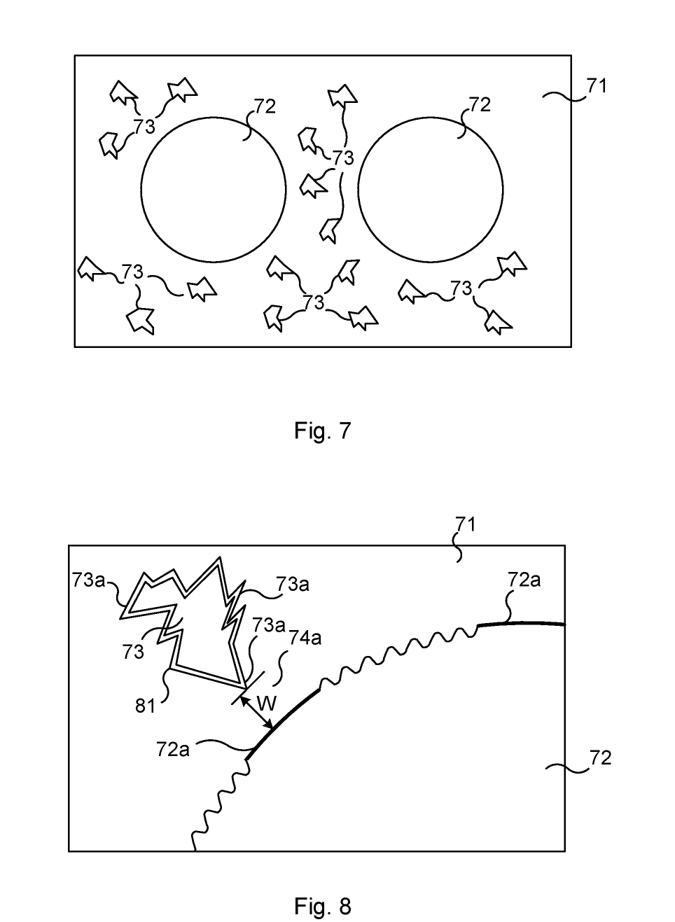

Next, with reference to FIGS. 7-9, a compound which can be used in the main section of the above embodiments will be described.

FIG. 7 illustrates, schematically, a portion of a compound having a temperature dependent electrical resistivity according to an embodiment. The compound comprises an electrically insulating bulk material 71, electrically conductive particles 72 of a first kind, and electrically conductive particles 73 of a second kind arranged in the bulk material 71.

The bulk material 71 may comprise an amorphous cross-linked polymer or elastomer, such as for example a siloxane elastomer (often called silicone elastomer) such as polyfluorosiloxane or polydimethyl siloxane and possibly also a filler, thickener, or stabilizer, such as silica. The bulk material holds the particles of the first and second kinds firmly in place in the bulk material after cross-linking. The filler, thickener, or stabilizer may be mixed with the bulk material to obtain a compound having a desired consistence, flexibility, and/or elasticity.

The electrically conducting particles 72, 73 of the first and second kinds may be carbon-containing particles, such as for example carbon blacks. The particles 73 of the second kind may (i) be smaller, (ii) be more in number, (iii) have higher surface roughness, and (iv) have more irregular shape than the particles 72 of the first kind as being schematically illustrated in FIG. 7.

FIG. 8 illustrates schematically a detail of the structure of the compound in FIG. 7 in more detail including one particle 73 of the second kind and a portion of one particle 72 of the first kind firmly secured in the bulk material 71. It can be seen that the highly irregularly shaped particles 73 of the second kind comprise tips 73a and the more regularly shaped particles 72 of the first kind comprise even surface portions 72a. The tips 73a of the particles 73 of the second kind may be so sharp that the very ends of the tips 73a comprise a single atom or a few atoms only.

If the width w of a gap 74a between a tip 73a of one of the particles 73 of the second kind and an even surface portion 72a of one of particles 72 of the first kind is narrow enough, electrons are enabled to tunnel through the gap via the quantum tunneling effect.

In one embodiment, the particles 73 of the second kind may be covered by a lubricant 75, such as for example a homo-oligomer, e.g. vinylmethoxysiloxane homo-oligomer, as being illustrated for one of the particles 73 of the second kind in FIG. 8. The lubricant 95 may assist in a suitable positioning of the particles 73 of the second kind in the bulk material 71.

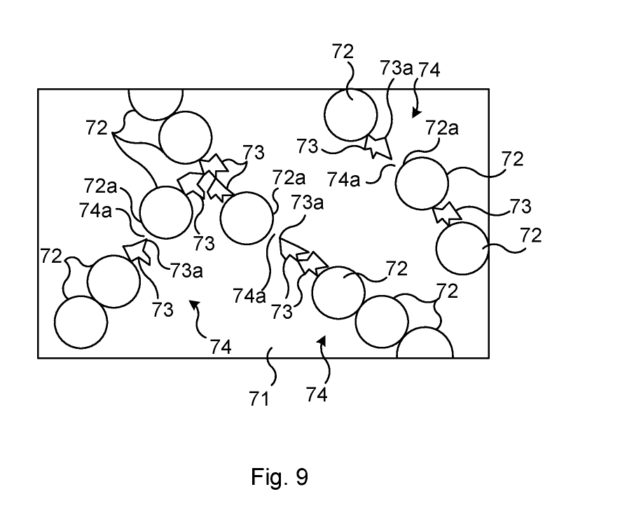

FIG. 9 illustrates schematically a portion of the compound, wherein a plurality of current paths 74 through the compound is shown. The particles 72, 73 of the first and second kinds are arranged to form the current paths 74 through the compound, wherein each of the current paths 74 comprises galvanically connected particles 72, 73 of the first and second kinds and a gap 74a between a tip 73a of one of the particles 73 of the second kind and an even surface portion 72a of one of the particles 72 of the first kind, wherein the gap 74a has a width which is small enough to allow electrons to tunnel through the gap via the quantum tunneling effect. While, FIG. 9 illustrates three current paths through the compound, it shall be appreciated that there may be thousands of current paths per square millimeter through a film of the compound. At a certain gap width w of the current paths 74, the quantum tunneling effect disappears and the compound does not conduct any longer.

The bulk material 71 has a thermal expansion capability such that it expands with temperature, thereby increasing the gap widths w of the current paths 74, which in turn increases the electrical resistivity of the compound exponentially.

The number of the current paths 74 through the compound and the widths w of the gaps 74a therein at any given temperature are provided depending on the thermal expansion capability of the compound to obtain an accentuated, e.g. exponential, temperature dependent electrical resistivity of the compound in a selected temperature interval.

The number of the current paths 74 through the compound, the widths w of the gaps 74a therein, and the thermal expansion capability of the compound can be controlled by adjusting the various ingredients of the compound, varying the amounts of the various ingredients of the compound, varying the order and manner in which they are mixed, and/or varying the cross-linking of the polymer or elastomer comprised in the bulk material.

The particles of the second kind may be covered by a lubricant before the particles of the first and second kinds are arranged in the bulk material. To this end, the particles of the second kind and the lubricant are mixed together in a solvent, after which the solvent is removed. The mixture of the particles of the second kind and the lubricant may be mixed with the filler, thickener, or stabilizer in a solvent, after which the solvent is removed. The mixture of the particles of the second kind, the lubricant, and the filler, thickener, or stabilizer may be mixed with the mixture of the particles of the first kind and the polymer or elastomer to obtain the compound.

Alternatively, the filler, thickener, or stabilizer may be mixed with the particles of the first kind and/or the polymer or elastomer, to which the mixture of the particles of the second kind and the lubricant is added.

In one example the compound is made up the following ingredients and amounts thereof (as given in weight percentages based on the weight of the compound), wherein the carbon blacks of the first kind have an average size of 500 nm and the carbon blacks of the second kind have an average size of 50 nm:

| | |
|---|---|
| polydimethyl siloxane | 44 |
| silica | 3 |
| carbon blacks of the first kind | 48 |
| carbon blacks of the second kind | 4.95 |
| vinylmethoxysiloxane homo-oligomer | 0.05 |

It shall be appreciated that the individual sizes of the particles of each kind may vary quite much, such as e.g. by a factor 10. Therefore it is advantageous that the sizes are given as some kind of statistical sizes, such as e.g. average sizes.

The above compound can be tailored to obtain the desired accentuated temperature dependent electrical resistivity in any desired temperature interval in the temperature range of minus 100 to plus 100 degrees Celsius, and may have very low resistance, e.g. 1-10 ohms, in a lower portion of such temperature interval.

Further reference is given to our co-pending patent application entitled Compound having exponential temperature dependent electrical conductivity, use of such compound in a self-regulating heating element, self-regulating heating element comprising such compound, and method of forming such compound and filed with the Swedish Patent Office on Dec. 2, 2013. The contents of the co-pending patent application are hereby incorporated by reference.

Alternative materials, which can be used in the main section comprise PTC (positive temperature coefficient) ceramics or functional ceramics such as e.g. barium titanates, which have negative temperature electrical resistivity in a relatively high temperature interval, e.g. above 140 degrees Celsius, while the resistances at lower temperatures are still often above 100 ohms.

It shall be appreciated by a person skilled in the art that the above disclosed embodiments may be combined to form further embodiments falling within the terms of the claims, and that any measures are purely given as example measures.

1. An arrangement for measuring temperature comprising
a plurality of temperature sensors (11), each including a main section (12; 31; 41), and separated electrical terminals (13, 14; 13a-b; 34, 35; 44; 45), wherein the main sections of the temperature sensors are formed in one piece, forming an elongated body and wherein the electrical terminals are arranged alternately on a top surface and a bottom surface of the elongated main section, the main section having a temperature dependent electrical resistivity, preferably an accentuated temperature dependent electrical resistivity, and the electrical terminals being electrically connected to the main section; and
an arrangement (15) for measuring an electrical resistance configured to measure the electrical resistance over the electrical terminals, wherein the measured electrical resistance is indicative of the temperature of an object in thermal contact with the main section.

2. The arrangement of claim 1 comprising evaluating means (16) operatively connected to the arrangement for measuring an electrical resistance, wherein
the arrangement for measuring an electrical resistance is configured to transmit the measured electrical resistance to the evaluating means.

3. The arrangement of claim 2 wherein the evaluating means is configured to (i) hold or receive a threshold resistance corresponding to a threshold temperature, (ii) compare the measured electrical resistance with the threshold resistance, and (iii) send instructions to any of an alarming device, a cooling device, or a heating device in response to said comparison, in particular if the comparison reveals that the temperature, of which the measured electrical resistance is indicative, is higher than the threshold temperature, to which the threshold resistance is corresponding.

4. The arrangement of claim 1 wherein said main section (31; 41) is formed as an elongated section wherein the electrical terminals (34, 35; 44, 45) are electrically connected to the main section in two opposite end portions thereof.

5. The arrangement of claim 4 wherein the main section (31; 41) has a flat shape with a main extension direction which changes along the main section to extend over a two-dimensional area, preferably a flat meander like shape to extend over a two-dimensional area.

6. The arrangement of claim 5 wherein the elongated main section which extends over a two-dimensional area is arranged in thermal contact with a two-dimensional area portion of the object, wherein the measured electrical resistance over the electrical terminals is indicative of a maximum local temperature of the two-dimensional area portion of the object.

7. The arrangement of claim 4 wherein the elongated main section (31) has separated electrically conducting structures (36a-b, 37a-b, 38a-b) arranged alternately on a top surface and a bottom surface of the elongated main section along the main extension of the elongated main section.

8. The arrangement of claim 7 wherein each separated electrically conducting structure arranged on the top surface of the elongated main section overlaps with two electrically conducting structures arranged on the two bottom surface of the elongated main section.

9. (canceled)

10. The arrangement of claim 1 wherein the main section is of a PTC material.

11. The arrangement of claim 1 wherein (i) the main section has a trip temperature within a specified temperature interval, such as e.g. −100 to +100 degrees Celsius, above which trip temperature the temperature dependence of the electrical resistivity is stronger than the temperature dependence of the electrical resistivity below the trip temperature; (ii) the main section has an electrical resistivity as a function of temperature such that the temperature derivative of the electrical resistivity within the specified temperature interval is strictly increasing; or (iii) the main section has an electrical resistivity which is exponentially increasing with temperature at least within the specified temperature interval.

12. The arrangement of claim 10 wherein the arrangement for measuring an electrical resistance is configured to measure the temperature within the specified temperature interval.

13. The arrangement of claim 1 wherein the main section (12) and the electrical terminals (13, 14; 13a-b) are provided as a sheet.

14. The arrangement of claim 1 wherein the sheet is flexible.

15. (canceled)

16. (canceled)

17. The arrangement of claim 1 wherein the main section is of a compound comprising an electrically insulating bulk material (71), electrically conductive particles (72) of a first kind, and electrically conductive particles (73) of a second kind, wherein
the electrically insulating hulk material holds the electrically conducting particles of the first and second kinds in place;
the electrically conducting particles of the second kind are smaller than the electrically conducting particles of the first kind;
the electrically conducting particles of the second kind are more in number than the electrically conducting particles of the first kind;
the electrically conducting particles of the second kind have higher surface roughness than the electrically conducting particles of the first kind, wherein the electrically conducting particles of the second kind comprise tips (73a) and the electrically conducting particles of the first kind comprise even surface portions (72a);
the electrically conducting particles of the first and second kinds are arranged to form a plurality of current paths (74) through the compound, wherein each of said current paths comprises galvanically connected electrically conducting particles of the first and second kinds and a gap (74a) between a tip (73a) of one of the electrically conducting particles of the second kind and an even surface portion (72a) of one of the electrically conducting particles of the first kind, which gap is narrow enough to allow electrons to tunnel through the gap via the quantum tunneling effect, and
the electrically insulating bulk material has a thermal expansion capability such that it expands with temperature, thereby increasing the gap widths (w) of the current paths, which in turn increases the electrical resistivity.

18. The arrangement of claim 17 wherein the insulating bulk material comprises a cross-linked polymer or elastomer, such as for example a silicone, e.g. polydimethyl siloxane, and optionally a filler, thickener, or stabilizer, such as for example silica, distributed in said compound; and the electrically conducting particles of the first and second kinds are carbon containing particles, such as for example carbon blacks.

19. The arrangement of claim 17 wherein the tips of the electrically conducting particles of the second kind are so sharp that the very ends of the tips comprise a single atom or a few atoms only.

20. The arrangement of claim 17 wherein the number of the current paths through the compound and the widths of the gaps therein at any given temperature are provided depending on the thermal expansion capability of the electrically insulating bulk material to obtain the temperature dependent electrical resistivity of the compound in a selected temperature interval.

21. (canceled)

22. The arrangement of claim 1 wherein the plurality of said temperature sensors are arranged in a one- or two-dimensional array.

23. The arrangement of claim 1 wherein the plurality of said temperature sensors are serially connected to one another, wherein the arrangement for measuring an electrical resistance is configured to measure the electrical resistance over said series connection.

24. (canceled)

25. The arrangement of claim 23 wherein the main sections of the plurality of said temperature sensors form an elongated body (31; 41) having flat shape with a main extension direction which changes along the elongated body to cover a two-dimensional area.

26. The arrangement of claim 25 wherein the elongated body (31; 41) has a flat meander like Shape.

27. The arrangement of claim 1 wherein the arrangement for measuring an electrical resistance is configured to measure the electrical resistance over the electrical terminals (51a, 52a, 53a, 62a, 62b) of each of the temperature sensors independently, wherein the electrical resistance of each of the temperature sensors is indicative of the temperature of a local portion of an object in thermal contact with the main section of that temperature sensor.

28. The arrangement of claim 27 wherein the arrangement for measuring an electrical resistance comprises one electrical resistance meter for each temperature sensor, such that the electrical resistances of the temperature sensors can be measured simultaneously.

29. The arrangement of claim 27 wherein the arrangement for measuring an electrical resistance comprises one or more electrical resistance meters and a switching network arranged such that each temperature sensor can individually be electrically connected to the electrical resistance meter or one of the electrical resistance meters during a measurement period, such that the electrical resistances of at least two of the temperature sensors can be measured during separated measurement periods by a single electrical resistance meter.

30. The arrangement of claim 27 wherein the main sections of the plurality of temperature sensors are electrically insulated from one another.

31. (canceled)

32. A method for measuring temperature comprising
providing a plurality of temperature sensors (11), each including a main section (12; 31; 41), and separated electrical terminals (13, 14; 13a-b; 34, 35; 44, 45), wherein the main sections of the temperature sensors are formed in one piece, forming an elongated body and wherein the electrical terminals are arranged alternately on a top surface and a bottom surface of the elongated main section, wherein the main section has a temperature dependent electrical resistivity, preferably an accentuated temperature dependent electrical resistivity, and the electrical terminals are electrically connected to the main section;
arranging an object, of which a temperature is to be measured, in thermal contact with the main section, and
measuring the electrical resistance over the electrical terminals, wherein the electrical resistance is indicative of a temperature of the object in thermal contact with the main section.

33. The method of claim 32 wherein electrical resistance versus temperature data are retrieved for the main section and a temperature of the object is determined based on the measured electrical resistance and the retrieved data.

34. The method of claim 32 wherein (i) a threshold resistance corresponding to a threshold temperature is held or received, (ii) the measured electrical resistance is compared with the threshold resistance, and (iii) alarming, cooling, or heating is performed in response to said comparison, in particular if the comparison reveals that the temperature, of which the measured electrical resistance is indicative, is higher than the threshold temperature, to which the threshold resistance is corresponding.

35. The method of claim 32 wherein the electrical resistance is measured by the temperature sensor, in which the main section (31; 41) is elongated and the electrical terminals (34, 35; 44, 45) are electrically connected to the elongated main section in two opposite end portions thereof.

36. The method of claim 35 wherein the electrical resistance is measured by the temperature sensor, in which the elongated main section (31; 41) has flat shape with a main extension direction which changes along the main section to extend over a two-dimensional area.

37. The method of claim 35 wherein the electrical resistance is measured by the temperature sensor, in which the elongated main section (31; 41) has flat meander like shaped to extend over a two-dimensional area.

38. The method of claim 36 wherein the elongated main section which extends over a two-dimensional area is arranged in thermal contact with a two-dimensional area portion of the object, wherein the measured electrical resistance over the electrical terminals is indicative of a maximum local temperature of the two-dimensional area portion of the object.

39. The method of claim 35 wherein the electrical resistance is measured by the temperature sensor, in which the elongated main section (31) has separated electrically conducting structures (36a-b, 37a-b, 38a-b) arranged alternately on a top surface and a bottom surface of the elongated main section along the main extension of the elongated main section.

40. (canceled)

41. The method of claim 32 wherein
the electrical resistance is measured by the temperature sensor, in which the main section (i) is of a PTC material′, (ii) has a trip temperature within a specified temperature interval, such as e.g. −100 to +100 degrees Celsius, above which trip temperature the temperature dependence of the electrical resistivity is stronger than the temperature dependence of the electrical resistivity below the trip temperature; (iii) has a electrical resistivity as a function of temperature such that the temperature derivative of the electrical conductivity within the specified temperature interval is strictly increasing, or (iv) has an electrical resistivity which is exponentially increasing with temperature at least within the specified temperature interval; and wherein
the electrical resistance is measured to determine a temperature within said temperature interval or a suitable temperature interval.

42. The method of claim 32 wherein the electrical resistance is measured by the temperature sensor, in which the main section (12) and the electrical terminals (13, 14; 13a-b) are sheet-shaped and/or flexible.

43. The method of claim 32 wherein the electrical resistance is measured by the temperature sensor, in which the main section is of a compound comprising an electrically insulating bulk material (71), electrically conductive particles (72) of a first kind, and electrically conductive particles (73) of a second kind, wherein
the electrically insulating bulk material holds the electrically conducting particles of the first and second kinds in place;
the electrically conducting particles of the second kind are smaller than the electrically conducting particles of the first kind;
the electrically conducting particles of the second kind are more in number than the electrically conducting particles of the first kind;
the electrically conducting particles of the second kind have higher surface roughness than the electrically conducting particles of the first kind, wherein the electrically conducting particles of the second kind comprise tips (73a) and the electrically conducting particles of the first kind comprise even surface portions (72a);
the electrically conducting particles of the first and second kinds are arranged to form a plurality of current paths (74) through the compound, wherein each of said current paths comprises galvanically connected electrically conducting particles of the first and second kinds and a gap (74a) between a tip (73a) of one of the electrically conducting particles of the second kind and an even surface portion (72a) of one of the electrically conducting particles of the first kind, which gap is narrow enough to allow electrons to tunnel through the gap via the quantum tunneling effect, and
the electrically insulating bulk material has a thermal expansion capability such that it expands with temperature, thereby increasing the gap widths (w) of the current paths, which in turn increases the electrical resistivity.

44. The method of claim 43 wherein the electrical resistance is measured by the temperature sensor, in which the insulating bulk material comprises a cross-linked polymer or elastomer, such as for example a silicone, e.g. polydimethyl siloxane, and optionally a filler, thickener, or stabilizer, such as for example silica, distributed in said compound; and the electrically conducting particles of the first and second kinds are carbon-containing particles, such as for example carbon blacks.

45. The method of claim 43 wherein the electrical resistance is measured by the temperature sensor, in which the tips of the electrically conducting particles of the second kind are so sharp that the very ends of the tips comprise a single atom or a few atoms only.

46. The method of claim 32 wherein a plurality of said temperature sensor (11) is provided in a one- or two-dimensional array (18), the plurality of said temperature sensor being serially connected to one another, wherein
the plurality of said temperature sensor is arranged in thermal contact with a one- or two-dimensional area of the object; and
the electrical resistance over said series connection is measured, wherein the measured electrical resistance is indicative of a maximum local temperature of the one- or two-dimensional area of the object.

47. The method of claim 32 wherein a plurality of said temperature sensor (11) is provided in a one- or two-dimensional array (18), wherein
the plurality of said temperature sensor is arranged in thermal contact with a one- or two-dimensional area of the object; and
the electrical resistance over the electrical terminals of each of the temperature sensors is measured independently, wherein the electrical resistance of each of the temperature sensors is indicative of the temperature of a respective local portion of the one- or two-dimensional area of the object.
